(19) United States
(12) Patent Application Publication
(10) Pub. No.: US 2004/0093480 A1
(43) Pub. Date: May 13, 2004

(54) Data processor

(75) Inventors: Kesami Hagiwara, Higashiyamato (JP); Kazuya Hirayanagi, Komae (JP); Yasuo Sugure, Hachioji (JP); Takeshi Kataoka, Tokyo (JP); Seiji Takeuchi, Higashimurayama (JP); Hiromichi Yamada, Hitachi (JP); Yuichi Abe, Mito (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 10/689,083

(22) Filed: Oct. 21, 2003

(30) Foreign Application Priority Data
Oct. 31, 2002 (JP) 2002-317076

(51) Int. Cl. G06F 9/30

(52) U.S. Cl. 712/210

(57) ABSTRACT

A data processor of the present invention efficiently performs decision processing on register conflict. The data processor contains n-bit instructions and 2n-bit instructions in an instruction set and includes an instruction control unit that can decide whether registers specified in register specification fields of the instructions conflict between the instructions. The 2n-bit instructions including register specification fields have the register specification fields in the first half n bits thereof, and the register specification fields in the first half n bits comprise the same placement as register specification fields in the n-bit instructions. Shift operations required to cut out the register specification fields from the instructions, either 2n-bit or n-bit instructions, can be simplified or deleted by aligning the register specification fields in the 2n-bit instructions with those in the n-bit instructions.

### BACKGROUND OF THE INVENTION

The present invention relates to a data processor taking into account the efficiency of decision processing on register conflict from the standpoint of instruction sets or instruction formats.

In pipeline processing, which is one of techniques for speeding up computations by data processors such as microprocessors, since processing for a next instruction is started before the cycle of a preceding instruction ends, a destination register to which an execution result of the preceding instruction is returned may be used as a source register in a following instruction. In this case, until an execution result of the preceding instruction is returned to the destination register, the next instruction cannot use the contents of the destination register as source data. Such a relationship between registers is referred to as conflict of general purpose registers (simply referred to as register conflict). In a case where register conflict occurs, until an execution result of a preceding instruction is returned to a conflicting register, the pipeline is stalled, or forwarding control is performed to deliver the execution result of the preceding instruction directly to an execution stage of the next instruction from a temporary register or through a route for bypassing the general purpose registers.

A decision on register conflict is made by deciding the possibility of conflict among general purpose registers specified in register specification fields of plural instructions fetched before and after.

For register conflict decision, Patent Publication 1 describes a computer that detects register conflict by a conflict detection circuit for short instructions, and by software for long instructions. Patent Publication 2 describes a parallel arithmetic unit in which one register conflict detection circuit is provided for four instruction decoders. Patent Publication 3 describes an information processing unit in which one register conflict decision part is provided for plural instruction buffers.

### [Patent Publication 1]

Japanese Unexamined Patent Publication No. Hei 5-(1993)-257687

### [Patent Publication 2]

Japanese Unexamined Patent Publication No. Hei 7-(1995)-56735

### [Patent Publication 3]

Japanese Unexamined Patent Publication No. Hei 6-(1994)-149569

### SUMMARY OF THE INVENTION

The inventor studied a decision on register conflict among registers of instructions different in instruction word length such as 16 bits and 32 bits. According to the study, it was made clear that, if long instructions are provided with special register fields to extend their functions by increasing the number of operands, instruction decoders and the logic of register conflict decision become complicated and is unsuitable for high speed operation. The same is also true for cases where there is no correlation between 16-bit instructions and 32-bit instructions in terms of the placement of register specification fields. The Patent Publications 1 to 3 do not take that point into account.

An object of the present invention is to provide a data processor that can efficiently perform decision processing on register conflict.

Another object of the present invention is to provide a data processor that can contribute to reduction in the size of logical circuits required for decision processing on register conflict and instruction decoding.

The foregoing and other objects and novel features of the present invention will become apparent from this specification and the accompanying drawings.

Representative examples of the invention disclosed in the present application will be briefly described below.

[1] The data processor contains n-bit instructions and 2n-bit instructions in an instruction set and includes an instruction control unit (instruction control circuit) that can decide whether registers specified in register specification fields of the instructions conflict between the instructions. The 2n-bit instructions including register specification fields include the register specification fields in the first half n bits thereof, and the register specification fields in the first half n bits have the same placement as register specification fields in the n-bit instructions.

The instruction control unit, in response to register conflict, performs control such as the stalling of pipeline stages or the forwarding of operation data write to general purpose registers. Instruction execution control by the instruction control unit may be either single scalar or superscalar.

From the foregoing description, shift operations required to cut out the register specification fields from the instructions, either 2n-bit or n-bit instructions, can be simplified or deleted by aligning the register specification fields in the 2n-bit instructions with those in the n-bit instructions. Therefore, even if the 2n-bit instructions and the n-bit instructions coexist, information of the register specification fields can be rapidly cut out from the instructions to decide register conflict.

The number of bits of the register specification fields is different depending on the number of specifiable operands. Even if the number of specifiable operands is different depending on the types of operation codes, both 2n-bit instructions and n-bit instructions have the register specification fields placed in common positions. Also in such assumed cases, information of the register specification fields can be rapidly cut out from the instructions to decide register conflict.

Since no register specification fields are provided in a lower side of 2n-bit instructions, which is the latter half thereof, instructions of an n-bit fixed length instruction set can be easily expanded to 2n bits.

The present invention can apply easily to not only single scalar processors but also superscalar processors, increasing data processing performance.

Since instruction decoders and the logic of register conflict decision can be simplified, the present invention is suitable for RISC microprocessors containing both n-bit instructions and 2n-bit instructions that must operate fast.

[2] A data processor of another embodiment contains n-bit instructions and 2n-bit instructions in an instruction set and includes an instruction control part that can decide conflict of registers specified in register specification fields of instructions between instructions, wherein the 2n-bit instructions having register specification fields have the register specification fields in one of the first half n bits and the latter half n bits, and the placement of the register specification fields in the first half n bits or the latter half n bits is the same as the placement of register specification fields in the n-bit instructions.

Placing register specification fields in the latter half of 2n-bit instructions has the same effect as placing them in the first half thereof. However, in this case, instructions in an n-bit fixed length instruction set could be expanded to 2n bits with some sacrifice of ease of expansion.

Furthermore, the instruction set may contain both instructions in which register specification fields aligned with the register specification fields in the n-bit instructions are placed in the first half n bits of the 2n-bit instructions, and instructions in which register specification fields aligned with the register specification fields in the n-bit instructions are placed in the latter half n bits of the 2n-bit instructions. In a superscalar architecture that enables parallel execution by decoding instructions n bits at a time in parallel, such a mixture of instructions causes no reduction in throughput. In the case of a single scalar architecture that decodes instructions n bits at a time for execution, since recognition for instruction decoding results must be changed depending on whether register specification fields exist in the first half or latter half thereof, the size of a decode logic may increase somewhat.

[3] A data processor according to another aspect includes first n-bit instructions and second 2n-bit instructions each having register specification fields in an instruction set. The second instructions have register specification fields in one of the first half n bits or latter half n bits thereof, and the register specification fields in the first half n bits or latter half n bits have the same placement as the register specification fields in the first instructions. The data processor further includes third n-bit instructions having register specification fields. The third instructions and the second instructions are different from each other in the number of operands specifiable in the register specification fields, and register specification fields of the third instructions and those of the second instructions are aligned in the start of the register specification fields with respect to the start of the instructions.

### BRIEF DESCRIPTION OF THE DRAWINGS

FIG. 1 is a diagram illustrating part of instructions of a data processor according to the present invention;

FIG. 2 is a block diagram of a data processor according to the present invention;

FIG. 3 is a diagram illustrating different types of data transfer instructions (MOV instructions) as concrete examples of instructions of FIG. 1;

FIG. 4 is a block diagram illustrating a single-scalar-supporting logical configuration for performing instruction decode, register conflict decision, and pipeline control in an instruction flow unit;

FIG. 5 shows a detailed example of an execution unit to explain forwarding operation;

FIG. 6 is a diagram illustrating the operation of bypassing pipeline install and performing forwarding;

FIG. 7 is a block diagram showing a super-scalar-supporting logical configuration for performing instruction decode, register conflict decision, and pipeline control in an instruction flow unit;

FIG. 8 is a diagram illustrating a second example of register specification fields;

FIG. 9 is a diagram illustrating other examples of register specification fields;

FIG. 10 is a diagram illustrating further other examples of register specification fields; and

FIG. 11 is a diagram illustrating further other examples of register specification fields.

### DETAILED DESCRIPTION OF THE PREFERRED EMBODIMENTS

### <<Data Processor>>

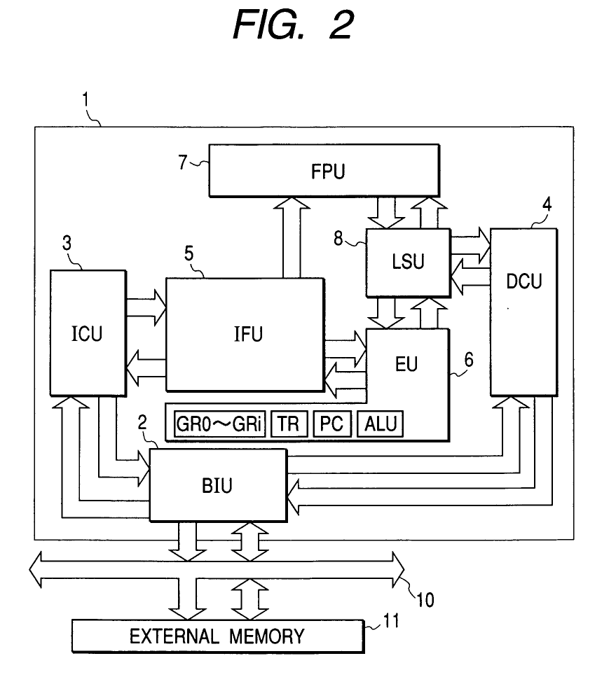

FIG. 2 shows a data processor according to an embodiment of the present invention. A data processor 1 includes: a bus interface unit (BIU) 2 through which data is inputted to and outputted from external memory and peripheral circuits; an instruction cache unit (ICU) 3; a data cache unit (DCU) 4; an instruction flow unit (IFU) 5 that performs processing such as instruction fetch and decode, and execution scheduling; an execution unit (EU) 6, a floating-point operation unit (FPU) 7, and a load/store unit (LSU) 8. The data processor 1 executes instructions by a pipeline method and performs processing in units of pipeline stages such as instruction fetch, decode, execute, and write back. The instruction scheduling of the pipeline stages is controlled by the instruction flow unit 5. The instruction flow unit 5 and the execution unit 6 make up the central processing unit (CPU), with the instruction flow unit 5 positioned as an instruction control part and the execution unit 6 as an execution part.

The instruction flow unit 5 decodes an instruction read from the instruction cache memory 3 and decides register conflict. According to the results, the instruction flow unit 5 controls an instruction execution procedure such as pipeline control and fetch/branch control, and performs operation control over the execution part and the like. When memory access is required in the operation control, the instruction flow unit 5 accesses the data cache unit 4 through the load/store unit 8, and if required, accesses the external memory 11 through the bus interface unit 2. When an instruction is fetched, the instruction flow unit 5 issues a fetch request to the instruction cache memory 3 according to fetch/branch control to access the instruction cache unit 3, and if required, accesses the external memory 11 through the bus interface unit 2.

The execution unit 6 has general purpose registers (GR0 to GRi), temporary register (TR), program counter (PC), arithmetic logic unit (ALU), and the like, and performs various operations on the basis of control signals and the like generated in the instruction flow unit 5.

The bus interface unit 2 is connected to an external bus 10. The external memory 11 representatively shown is connected to the external bus 10. The external memory 11 is a main memory used as a program memory, a work area, and the like. The data processor 1 has peripheral circuits (not shown in the figure) connected to the bus interface unit 2, such as, e.g., a timer counter and serial input/output circuits.

### <<First Example of Register Specification Field>>

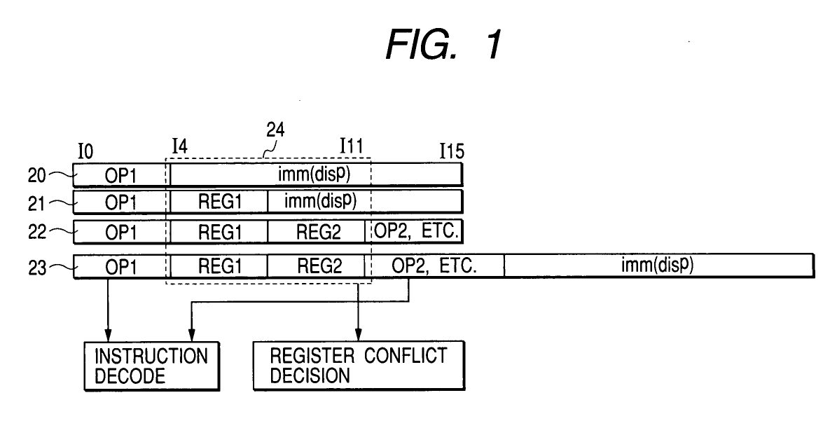

FIG. 1 shows examples of instructions contained in an instruction set of the data processor 1. The reference numbers 20 to 22 designate 16-bit instructions representatively shown and 23 designates a 32-bit instruction representatively shown. OP1 and OP2 are operation fields; REG1 and REG2 are register specification fields; imm is an immediate value specification field; and disp is a displacement field. As shown in the drawing, 16-bit instructions and 32-bit instructions coexist in the instruction set of the data processor. Register numbers are specified in the fields REG1 and REG2, respectively. One or two register operands are specified by register numbers. The 32-bit instruction 23 having register specification fields REG1 and REG2 has the register specification fields in the first half thereof so that they are aligned with the register specification fields REG1 and REG2 in the 16-bit instructions 21 and 22. Specifically, the 32-bit instruction (second instruction) 23 has register specification fields REG1 and REG2 in the first 16 bits thereof, and the register specification fields in the first half 16 bits have the same placement as the register specification fields REG1 and REG2 in the 16-bit instruction 22 (first instruction). The 16-bit instruction (third instruction) 21 and the 32-bit instruction (second instruction) are different from each other in the number of operands specifiable in the register specification fields, and the register specification field REG1 of the 16-bit instruction (third instruction) 21 and the register specification fields REG1 and REG2 in the 32-bit instruction (second instruction) 23 are aligned in the start of the register specification field REG1 with respect to the start of the instructions. In short, the register specification fields are made to fit in a fixed field 24 regardless of different types of instructions. In fields outside the field 24, no registers are specified.

Operation codes specified in the operation code fields OP1 and OP2 are decoded into instructions. Register numbers specified in the register specification fields REG1 and REG2 are subjected to register conflict decision.

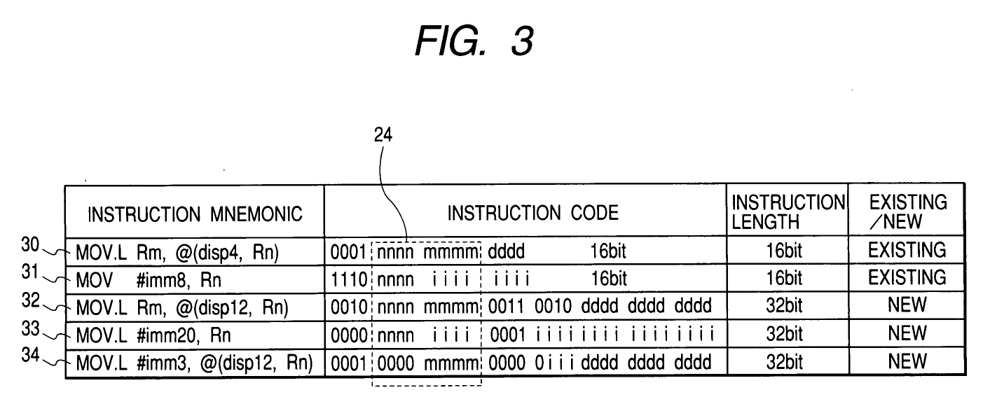

FIG. 3 shows different types of data transfer instructions (MOV instructions) as concrete examples of instructions corresponding to the instruction formats of FIG. 1. nnnn designates a register number set in REG1, mmmm designates a register number set in REG2, iiii . . . designates an immediate value, and dddd . . . designates a displacement.

An instruction 30 transfers the value of register Rm to a memory address specified in addressing mode @ (disp4, Rn). The addressing mode @ (disp4, Rn) is register indirectly addressing mode with a displacement in which a value obtained by adding a 4-bit displacement to register Rn is used as an access address. This instruction corresponds to the instruction 22.

An instruction 31 is a transfer instruction that loads an 8-bit immediate value #imm8 into register Rn. This instruction corresponds to the instruction 21.

An instruction 32 transfers the value of register Rm to a memory address specified in addressing mode @(disp12, Rn). The instruction 32 is a 32-bit instruction having an increased number of bits of the displacement of the instruction 30, and corresponds to the instruction 23.

An instruction 33 is a transfer instruction that loads a 20-bit immediate value #imm20 into register Rn. The instruction 33 is a 32-bit instruction having an increased number of bits of the immediate value of the instruction 31.

An instruction 34 transfers an immediate value #imm3 to a memory address specified in addressing mode @(disp12, Rn).

Also in the examples of FIG. 3, register specification fields are made to fit in the fixed field 24 regardless of different types of instructions. In fields outside the field 24, no registers are specified. In FIG. 3, “new” instructions 32, 33, and 34 denote new instructions in cases where 32-bit extended instructions are assumed to be added to 16-bit instructions (“existing” instructions) of a 16-bit fixed length instruction set.

### <<Register Conflict Decision In Single Scalar>>

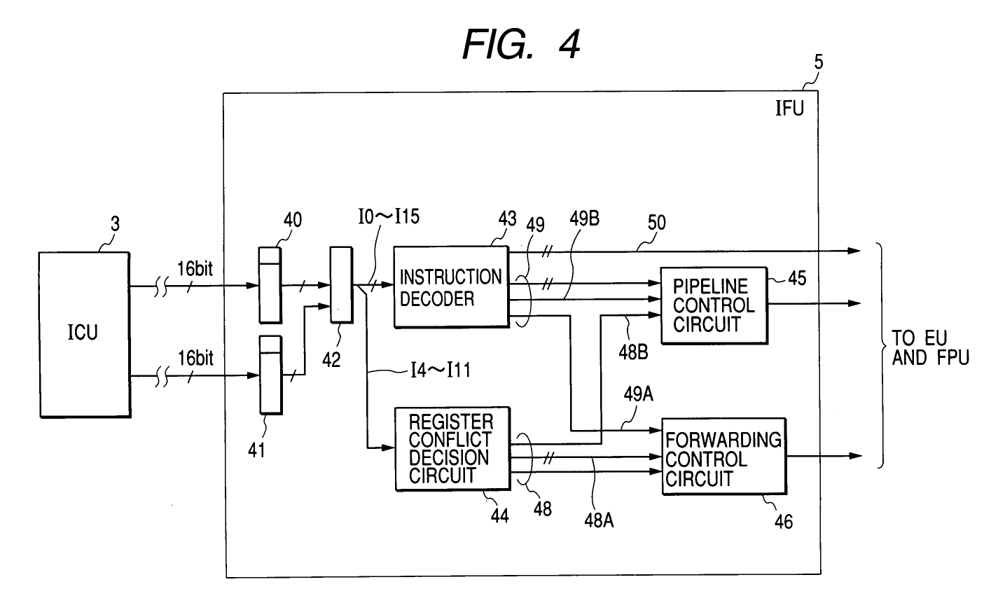

FIG. 4 shows a logical configuration for performing instruction decode, register conflict decision, and pipeline control in the instruction flow unit 5. The logic shown here corresponds to pipeline control of single scalar and controls instruction execution through one pipeline.

The instruction flow unit 5 includes 16-bit instruction registers 40 and 41, a selector 42, an instruction decoder 43, a register conflict decision circuit 44, a pipeline control circuit 45, and a forwarding control circuit 46.

By instruction fetch control, instructions are fetched 32 bits at a time from the instruction cache memory ICU 3 to the instruction registers 40 and 41. The instructions fetched to the instruction registers 40 and 41 are alternately selected by the selector 42, and decoded 16 bits at a time by the instruction decoder 43. If the output of the selector 42 is I0 to I15, of 16 bits I0 to I15 selected by the selector 42, code I4 to I11 of the field 24 corresponding to the register specification field is supplied to the register conflict decision circuit 44. The register conflict decision circuit 44 decodes code I4 to I11 successively inputted and decides the possibility of register conflict. A decision result is delivered as control information 48 to the forwarding control circuit 46 and the pipeline control circuit 45. The instruction decoder 43 decodes instruction code in parallel to the register conflict decision, and delivers a decode result to the pipeline control circuit 45 and the forwarding control circuit 46 as control information 49. An immediate value and a displacement in the instruction are cut out and outputted as data information 50. The data information, control information outputted from the pipeline control circuit 45, and control information outputted from the forwarding control circuit 46 are outputted to EU6 and FPU7 for each of pipeline stages and are used to control their operation.

Control based on register conflict decision will be described in detail. The register conflict decision circuit 44 inputs code I4 to Ill and decides the possibility of register conflict. Specifically, it is decided whether there is a possibility that a destination register specified in a preceding instruction matches a source register specified in a following instruction. Control information 48A indicating whether forwarding is possible for a result of the register conflict decision is delivered to the forwarding control circuit 46. Control information 48B indicating whether pipeline stall is required for the register conflict decision result is delivered to the pipeline control circuit 45. Since register conflict decision based on the code I4 to I11 is made in parallel to the instruction decode in this example, some types of instructions contain no register specification field in the code I4 to I11, which actually may contain an immediate value or a displacement. Since the number of bits of instructions and the number of register operands are decoded by the instruction decoder 43, a status of the instructions is made clear by decoding the operation code, and if it is determined that there is no possibility that register conflict occurs between several adjacent instructions, from the types of the instructions, the instruction decoder 43 delivers control information 49A indicating that forwarding is invalid (or canceled) for the conflict decision result, to the forwarding control circuit 46, and delivers control information 49B indicating that pipeline stall is canceled, to the pipeline control circuit 45.

According to the first example of the register specification field, since both 32-bit instructions and 16-bit instructions have register specification fields REG1 and REG2 placed within the field 24, shift operations required to cut out the register specification fields from the instructions, either 32-bit or 16-bit instructions, can be simplified or deleted. Code I4 to I11 has only to be supplied to the register conflict decision circuit 44. Therefore, even if 32-bit instructions and 16-bit instructions coexist, information of the register specification fields can be rapidly cut out from the instructions to decide register conflict.

The number of bits of the register specification fields is different depending on the number of specifiable operands. Even if the number of specifiable operands is different depending on the types of operation codes, both the 32-bit instructions and 16-bit instructions have the register specification fields placed within the field 24. Therefore, even in cases where the number of register operands is different, information of the register specification fields can be rapidly cut out from the instructions to decide register conflict.

Since no register specification fields are provided in the latter half of 32-bit instructions, instructions of a 16-bit fixed length instruction set can be easily expanded to 32 bits. In short, for 32-bit instructions, if register specification fields are placed in their first half, only the first half of the 32-bit instructions has only to be decoded to provide indications of forwarding cancel and pipeline stall cancel for register conflict, resulting in the same control sequence for 16-bit instructions.

Instruction fetch for the instruction registers 40 and 41 is embodied between: a 16-bit instructions and a 16-bit instruction; a 16-bit instruction and the first 16 bits of a 32-bit instruction; the latter 16 bits of a 32-bit instruction and a 16-bit instruction; and the first 16 bits and the latter 16 bits of a 32-bit instruction. In any cases, in the order of the instruction registers 40 and 41, instruction decode and register conflict decision are made every 16 bits. As is apparent from the above-described embodiments, although decision targets in the register conflict decision may not be information of register specification fields, undesired decision results obtained by it are modified by the control information 49A and 49B formed by instruction decoding performed in parallel.

### <<Forwarding Operation>>

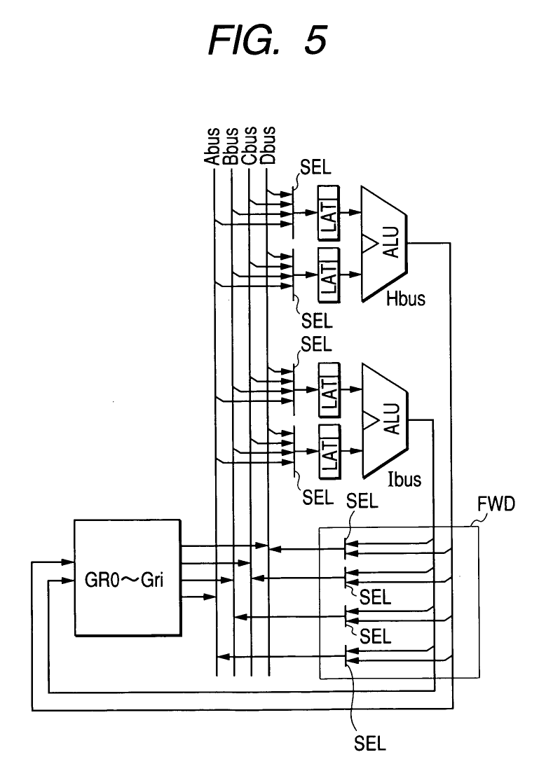

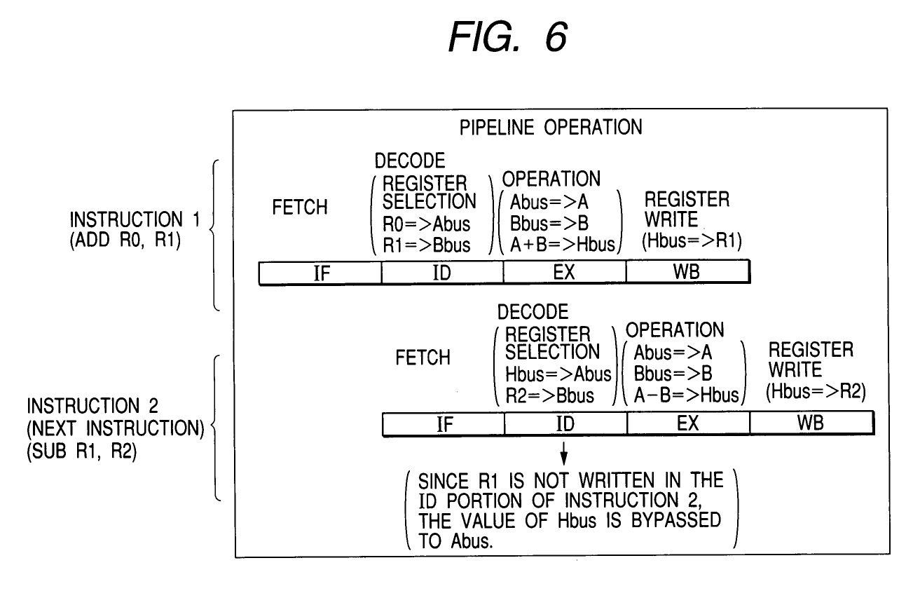

FIGS. 5 and 6 show an example of forwarding operation. FIG. 5 shows a detailed example of the execution unit 6. ALU designates an arithmetic logic unit; LAT, an input latch; FWD, a forwarding unit; GR0 to GRi, general purpose registers; and SEL, a selector. An internal bus is multiplexed with Abus, Bbus, Cbus, and Dbus, and the output of the arithmetic logic unit (ALU) can be supplied to the general purpose registers GR0 to GRi through the buses Hbus and Ibus. The forwarding unit FWD forms a bypass circuit to selectively supply the values of the buses Hbus and Ibus to the buses Abus, Bbus, Cbus, and Dbus.

A destination register R1 in an instruction 1 (add instruction ADD) shown in FIG. 6 is used as a source register R1 in an instruction 2 (subtract instruction SUB). Each of the instructions is executed through a four-stage pipeline consisting of fetch stage (IF), decode stage (ID), execution stage (EX), and register write stage (WB). In the decode stage of the instruction 2, an execution result of the instruction 1 is not yet written back to the register R1. Accordingly, an execution result obtained in the execution stage (EX) of the instruction 1 is supplied to the bus Abus via the forwarding unit FWD from the bus Hbus. The value of the register R2 is supplied to, e.g., the bus Bbus, whereby, in the execution stage (EX) of the instruction 2, the value of the register R2 can be subtracted from the execution result of the instruction 1 supplied to the bus Abus by the arithmetic logic unit ALU. Accordingly, in the execution stage of the instruction 2, it can be prevented that the pipeline is stalled one stage.

### <<Register Conflict Decision In Superscalar>>

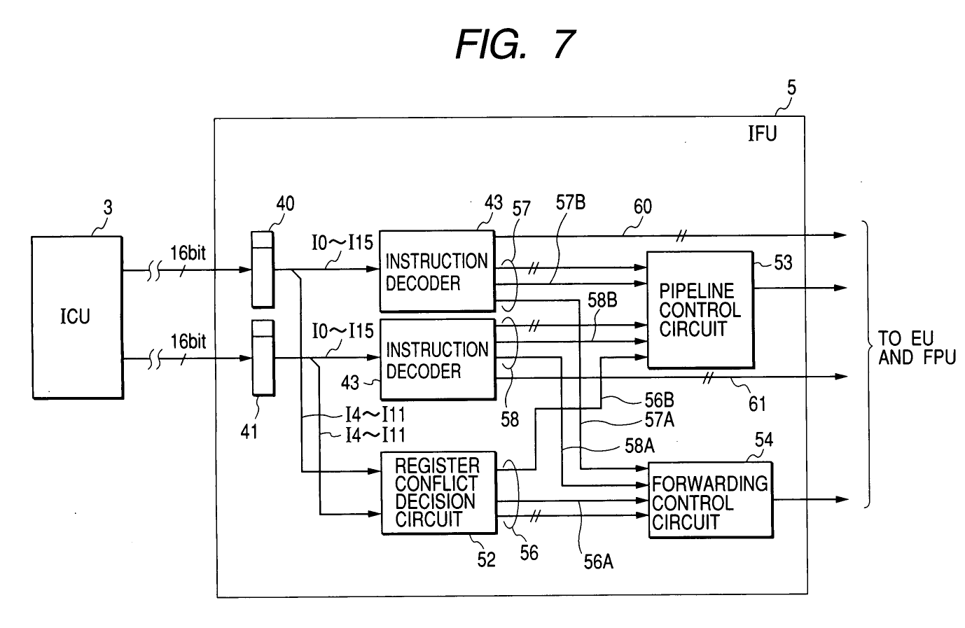

A description is made of the data processor 1 employing a superscalar function capable of processing instructions in parallel through plural pipelines. FIG. 7 shows a logical configuration for performing instruction decode, register conflict decision, and pipeline control in the instruction flow unit 5 in the case where the data processor 1 is configured as a two-way superscalar processor. In the example of FIG. 7, the instruction flow unit 5 includes 16-bit instruction registers 40 and 41, instruction decoders 43, a register conflict decision circuit 52, a pipeline control circuit 53, and a forwarding control circuit 54.

The 16-bit instruction decoders 43 are provided correspondingly to the instruction registers 40 and 41, respectively, and can decode instructions on a 16-bit basis in parallel. The register conflict decision circuit 52 inputs I4 to I11 in 16 bits of the instruction registers 40 and 41 and decides the possibility of conflict between general purpose registers used in adjacent instructions, like the register conflict decision circuit 44. A result of the decision on register conflict is delivered as control information 56 to the forwarding control circuit 54 and the pipeline control circuit 53. The instruction decoders 43 decode instruction codes in parallel with the register conflict decision, and a decode result is delivered to the pipeline control circuit 53 and the forwarding control circuit 54 as control information 57 and 58. An immediate value and a displacement in instructions are cut out and outputted as data information 60 and 61. The data information, the control information outputted from the pipeline control circuit 53, and the control information outputted from the forwarding control circuit 54 are outputted to the EU 6 and FPU 7 for each of pipeline stages and used to control their operation.

Control based on register conflict decision is described in detail. The register conflict decision circuit 52 successively inputs code I4 to I11 from the instruction registers 40 and 41 and decides the possibility of register conflict. Specifically, it is decided whether there is a possibility that a destination register specified in a preceding instruction matches a source register specified in a following instruction. Control information 56A indicating whether forwarding is possible for a result of the register conflict decision is delivered to the forwarding control circuit 54. Control information 56B indicating whether pipeline stall is required for a result of the register conflict decision is delivered to the pipeline control circuit 53. Since register conflict decision based on the code I4 to I11 is made in parallel to the instruction decode in this example, some types of instructions contain no register specification field in the code I4 to I11, which actually may contain an immediate value or a displacement. Since the number of bits of instructions and the number of register operands are decoded by the instruction decoders 43, a status of the instructions is made clear by decoding the operation code, and if it is determined that there is no possibility that register conflict occurs between several adjacent instructions, from the types of the instructions, the instruction decoders 43 deliver control information 57A and 58A indicating that forwarding is invalid (or canceled) for the conflict decision result, to the forwarding control circuit 54, and delivers control information 57B and 58B indicating that pipeline stall is canceled, to the pipeline control circuit 53.

According to the first example of a register specification field, also for superscalar, like single scalar, information of the register specification field can be rapidly cut out from instructions to decide register conflict.

### <<Second Example of Register Specification Field>>

A second example of a register specification field is described. A register specification field in this example has an increased degree of freedom of placement thereof. If the IFU 5 supports the superscalar in FIG. 7, the format of the register specification field guarantees that the same operation effect as single scalar is obtained.

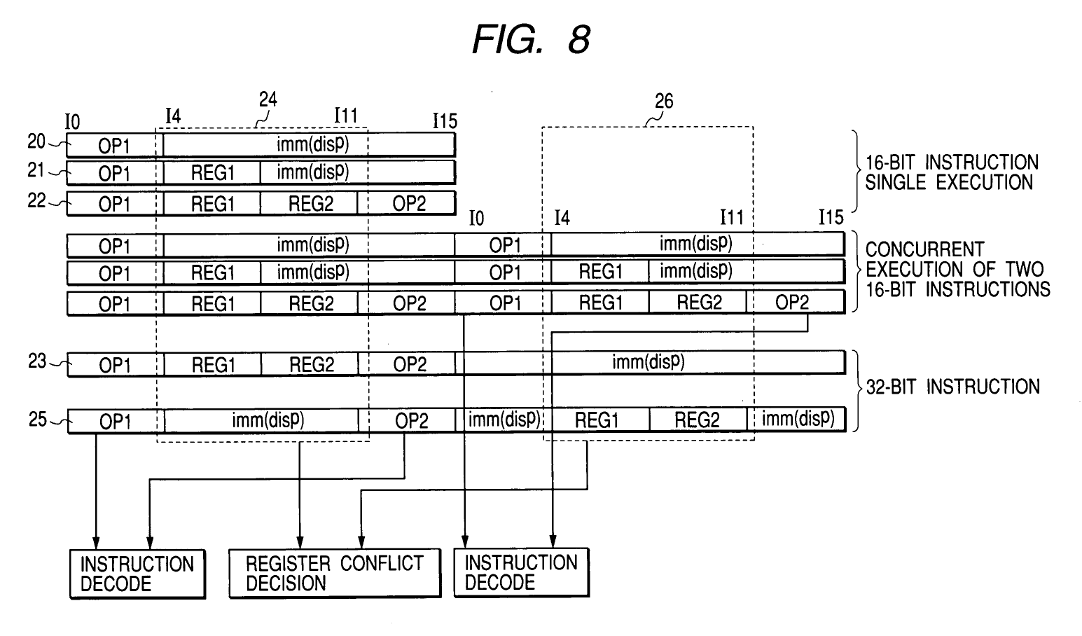

FIG. 8 shows a second example of register specification fields. Since the IFU 5 supporting superscalar includes the two instruction decoders 43 capable of decode operation in parallel on a 16-bit basis, when two 16-bit instructions are decoded in parallel and when a 32-bit instruction is decoded by the two instruction decoders 43, if register specification fields are equivalently handled, the register specification fields are not always required to be placed in the first half of 32-bit instructions, like the first example. Specifically, as shown in the field “Concurrent execution of two 16-bit instructions” in FIG. 8, the 16-bit instructions 20, 21, and 22 are successively fetched and separately decoded in parallel. This includes both the case where a register specification field exists in the first half of a 32-bit instruction and the case where a register specification field exists in the latter half of a 32-bit instruction. Therefore, in the case where superscalar is supported, even if an instruction format is adopted which contains register specification fields in one of an area 24 in the first half 16 bits and an area 26 in the latter half 16 bits, the same effect as the first example can be obtained. In short, an instruction set may contain both 32-bit instructions having I4 to I11 of the first half 16 bits as register specification fields as shown by an instruction 23, and 32-bit instructions having I4 to I11 of the latter half 16 bits as register specification fields as shown by an instruction 25. In instruction formats of FIG. 8, since both 32-bit instructions and 16-bit instructions have register specification fields REG1 and REG2 placed within a field 24 or 26, shift operations required to cut out the register specification fields REG1 and REG2 from the instructions, either 32-bit or 16-bit instructions, can be simplified or deleted. Code I4 to I11 has only to be supplied to the register conflict decision circuit 52. Therefore, even if 32-bit instructions and 16-bit instructions coexist, information of the register specification fields can be rapidly cut out from the instructions to decide register conflict.

Even if register specification fields are provided in the latter half of 32-bit instructions, since the two 16-bit decoders 43 are provided to support two-way superscalar, by taking full advantage of them, without complicating register decision and instruction decoding and increasing logic size, constraints on the placement of the register specification fields in 32-bit instructions can be relaxed to a greater degree than in the first example.

### <<Other Example of Register Specification Field>>

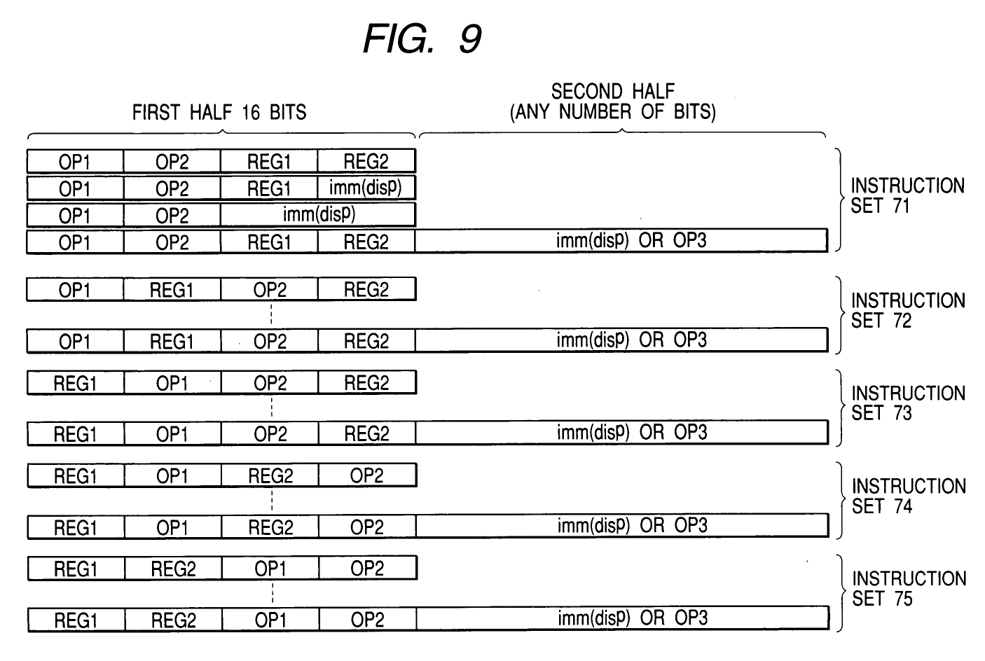

The placements of register specification fields may be any of those of instruction sets 71 to 75 shown in FIG. 9, in contrast to those of the first example 1. The present invention can also apply to data processors having such instruction sets. Specifically, the formats of the first half 16 bits of 32-bit instructions are the same as those of 16-bit instructions, and in the latter half 16 bits, an immediate value imm, operation code OP3, and the like are placed. In short, if a correlation with the register specification fields of 16-bit instructions is maintained, the register specification fields REG1 and REG2 or operation codes OP1 and OP2 in the first half 16 bits may be placed in any position.

As shown in FIG. 9, if no register field is contained in the latter half of instructions, which are not limited to 32-bit instructions, the latter half may have any predetermined number of bits. In short, 32-bit instructions may be further expanded.

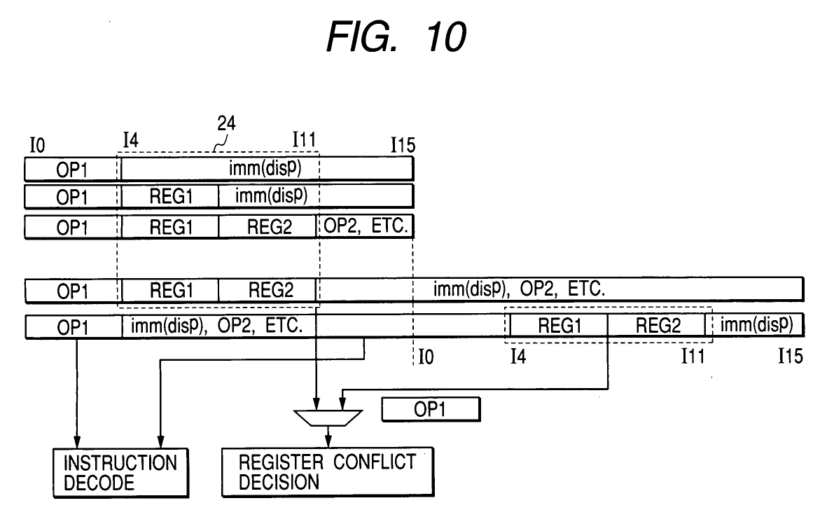

Even data processors of single scalar may adopt an instruction format containing register specification fields in the latter half 16 bits of 32-bit instructions, as shown in FIG. 10. This case also requires the condition that the placement of register specification fields in the latter half 16 bits is aligned with the placement of register specification fields in 16-bit instructions. This also contributes to simplification of register conflict decision logic.

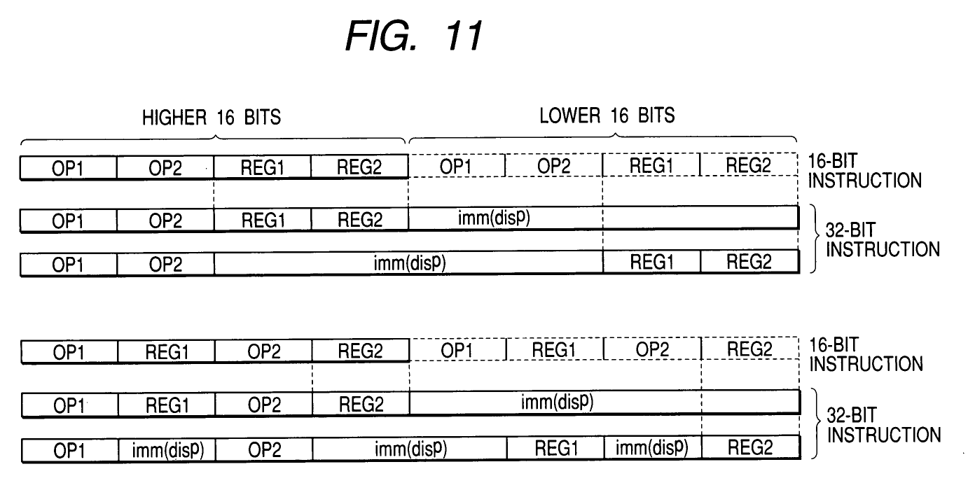

In data processors of superscalar, if the placement of register specification fields in the first half 16-bit part and the latter half 16-bit part of 32-bit instructions is the same as that of 16-bit instructions, the positions of the register specification fields are not limited to those of FIG. 8, and may be changed as required as shown in FIG. 11.

Although the invention made by the inventor has been described in detail on the basis of the embodiments, it goes without saying that the present invention is not limited to the embodiments and may be changed in various ways without departing from the spirit and scope thereof.

For example, the circuit modules included in the data processor are not limited to those in FIG. 2, and the data processor may be configured so that a cache memory is not adopted, an on-chip RAM is provided instead, FPU is not provided, and an address conversion module such as MMU is provided. The number of bits of instructions is not limited to 16 bits and 32 bits.

Instructions supplied to the instruction flow unit (IFU) 5 are not limited to instructions stored in the instruction cache unit ICU 3. Instructions may be supplied from any memories that can supply instructions, such as, e.g., internal RAM and internal ROM (not shown in the figure), and external memory.

Effects of representative examples of the invention disclosed in the present application are briefly described below.

Shift operations for cutting out register specification fields from instructions, either 2n-bit instructions or n-bit instructions, can be simplified or deleted by aligning the register specification fields in the 2n-bit instructions with those in the n-bit instructions. Therefore, even if 2n-bit instructions and n-bit instructions coexist, information of the register specification fields can be rapidly cut out from the instructions to decide register conflict.

The size of logical circuits required for decision processing on register conflict and instruction decoding can be reduced.

The present invention can apply easily to not only single scalar processors but also superscalar processors, increasing data processing performance.

Since instruction decoders and a register conflict decision logic can be simplified, the present invention is suitable for RISC microprocessors containing both n-bit instructions and 2n-bit instructions that must operate fast.

What is claimed is:

1. A data processor comprising n-bit instructions and 2n-bit instructions in an instruction set and including an instruction control unit that can decide whether registers specified in register specification fields of the instructions conflict between the instructions,
wherein the 2n-bit instructions including register specification fields include the register specification fields in the first half n bits thereof, and
wherein the register specification fields in the first half n bits have the same placement as register specification fields in the n-bit instructions.

2. A data processor comprising n-bit instructions and 2n-bit instructions in an instruction set and including an instruction control unit that can decide whether registers specified in register specification fields of the instructions conflict between the instructions,
wherein the 2n-bit instructions including register specification fields include the register specification fields in one of the first half n bits or latter half n bits thereof, and
wherein the register specification fields in the first half n bits or latter half n bits include the same placement as register specification fields in the n-bit instructions.

3. The data processor according to claim 2,
wherein the instruction set comprises instructions in which register specification fields aligned with the register specification fields in the n-bit instructions are placed in the first half n bits of the 2n-bit instructions, and
wherein the instruction set further comprises instructions in which register specification fields aligned with the register specification fields in the n-bit instructions are placed in the latter half n bits of the 2n-bit instructions.

4. The data processor according to claim 1,
wherein n bits are 16 bits, and 2n bits are 32 bits.

5. The data processor according to claim 1,
wherein the instruction control unit, in response to register conflict, is able to perform control such as the stalling of pipeline stages or the forwarding of operation data write to general purpose registers.

6. The data processor according to claim 1,
wherein the data processor is able to execute instructions in single scalar mode.

7. The data processor according to one of claims 1 to 3,
wherein the data processor can execute instructions

8. The data processor according to claim 2,
wherein the instruction control unit, in response to register conflict, is able to perform control such as the stalling of pipeline stages or the forwarding of operation data write to general purpose registers.

9. A data processor comprising first n-bit instructions and second 2n-bit instructions each including register specification fields in an instruction set,
wherein the second instructions are instructions with an immediate value or displacement value extended to the first instructions,
wherein the second instructions include register specification fields in the first half n bits thereof, and
wherein the register specification fields in the first half n bits of the second instruction comprises the same placement as the register specification fields in the first instructions.

10. The data processor according to claim 9,
wherein the data processor includes third n-bit instructions including register specification fields,
wherein the third instructions and the second instructions are different from each other in the number of operands specifiable in the register specification fields, and and
wherein register specification fields of the third instructions and those of the second instructions are aligned in the start of the register specification fields with respect to the start of the first instructions.

11. A data processor comprising first n-bit instructions and second 2n-bit instructions each including register specification fields in an instruction set,
wherein the second instructions include register specification fields in one of the first half n bits and the latter half n bits thereof, and
wherein the placement of the register specification fields in the first half n bits or the latter half n bits is the same as the placement of the register specification fields in the first instructions.

12. The data processor according to claim 11,
wherein the data processor includes third n-bit instructions including register specification fields,
wherein the third instructions and the second instructions are different from each other in the number of operands specifiable in the register specification fields, and
wherein register specification fields of the third instructions and those of the second instructions are aligned in the start of the register specification fields with respect to the start of the first instructions.
